(19) United States
(12) Patent Application Publication
(10) Pub. No.: US 2025/0134739 A1
(43) Pub. Date: May 1, 2025

(54) System and method to lift and weigh a patient

(71) Applicant: SAVARIA CONCORD LIFTS INC., Brampton (CA)

(72) Inventors: Dominic Parent Deroy, Sherbrooke (CA); Mathieu Beaupre, Sherbrooke (CA); Michel Corriveau, Saint-Denis-de-Brompton (CA); Stephane Lebrun, Sherbrooke (CA); Jonathan Benoit, Sherbrooke (CA); Mathew Howitt, Magog (CA); Marc-Andre Gervais, Sherbrooke (CA)

(21) Appl. No.: 18/929,970

(22) Filed: Oct. 29, 2024

Related U.S. Application Data
(60) Provisional application No. 63/594,142, filed on Oct. 30, 2023.

(51) Int. Cl. A61G 7/10

(52) U.S. Cl. CPC A61G 7/1051; A61G 7/1015; A61G 7/1019; A61G 7/104

(57) ABSTRACT

The present invention concerns an in-line lift system and method for a patient lift system with a scale. The system incorporates a load cell pivotally attached within a sling bar, allowing for precise weight measurement during patient transfers and allowing increased height to which the patient may be lifted. The load cell is integrated into a sling bar. The load cell may be attached to a cradle pivotally attached within a central portion of the sling bar. The attachment cup suspends the lift system and enables rotation. The lifting system further comprises a suspending assembly, a sling bar pivotally attached to the suspending assembly system about a vertical axis, a load cell pivotally attached in a central section of the sling bar and movement limiting assembly.

### CROSS-REFERENCE TO RELATED APPLICATIONS

The present patent application claims the benefits of priority of U.S. Provisional Patent Application No. 63/594,142, entitled “SYSTEM AND METHOD TO LIFT AND WEIGHT A PATIENT”, and filed at the United States Patent and Trademark Office on Oct. 30, 2023, the content of which is incorporated herein by reference.

### FIELD OF THE INVENTION

The present invention generally relates systems and method for lifting or hoisting a human being while weighing the said human being. More specifically, the present invention further relates to systems and methods for lifting a patient comprising an integrated scale to weigh the patient.

### BACKGROUND OF THE INVENTION

Ceiling-mounted overhead patient lift systems typically function as winches and are commonly equipped with a housing or frame secured to a ceiling rail. Such systems typically comprise a lift motor driving a cylindrical lift drum. A lift strap is attached to the drum. By rotating the drum, the strap can either wind up or pay out, allowing for the lifting or lowering of patients. On the other hand, floor lifts resemble pneumatic or hydraulic hoists and consist of a lift arm connected to one or more pneumatic or hydraulic cylinders to facilitate patient movement. These lifts are often used for various purposes, including weighing patients who are unable to stand on their own, such as wheelchair-bound individuals or bariatric patients following weight loss surgery.

Various methods exist for weighing a patient using an overhead lift, and one approach involves installing a portable in-line tension scale between the sling bar and either (1) the lift strap of a motorized ceiling lift or portable patient lift, or (2) the lifting end of the lift arm of a portable patient lift. An example of such an in-line scale is the LikoScale 350™, manufactured by Liko AB. The top end of the in-line scale is connected to the free-hanging portion of the lift strap or the lift end of the rigid lift arm, while the lower end is attached to the sling bar. As a load is lifted, the in-line scale experiences tension, enabling the measurement of the patient's weight.

However, using an in-line scale has certain drawbacks. Firstly, the scale's length reduces the available lift height by up to 8 inches, which can prevent patients seated below the sling bar from being fully lifted off a bed, chair, or other support. This limitation becomes particularly problematic in-patient rooms with low ceilings, making it challenging to obtain accurate weight measurements.

Moreover, in-line lift systems face an additional challenge as to the position of a loadcell which will give the measurement of the mass. The optimisation of the load cell position requires careful consideration of the following key factors, among others. First, the load cell should be positioned in a way that allows it to accurately measure the forces acting on the said load cell. Such positioning requires careful consideration of how the load is transmitted through the system, whether the load is transmitted through tension in a strap, compression in a lift arm, or other mechanisms. The load cell should be placed in a position where it experiences minimal external forces or moments that could introduce measurement errors. Achieving mechanical equilibrium ensures that the load cell accurately captures the weight or tension without additional forces influencing its readings. Moreover, load cells typically use strain gauge technology to measure the deformation caused by applied forces. The position of the load cell is typically optimized by placing such load cell in a location where it can effectively sense and measure the strain resulting from the load, maximizing the sensitivity and accuracy of the measurements. Further, the load cell position generally aims at minimizing any potential interference from external factors, such as vibrations, thermal effects, or unintended forces. Such optimization of the position of the load cell requires considering the system's environment and implementing measures to isolate the load cell from unwanted influences.

Following a careful analysis of the system, simulations and experimental testing, a strategic position is chosen in the line of tension, as close to the in-line scale as possible. Therefore, for in-line lifts, the optimum position of the load cell would be within the in-line scale, specifically between the lifting mechanism and the sling bar. Such arrangement allows the load cell to directly measure the tension in the lifting system, providing accurate weight measurements of the load being lifted. An example of such a placement is depicted by U.S. Pat. No. 9,693,922 B2, owned by Liko R&D AB, in which the load cell is placed directly into the scale, between the housing and the sling bar.

However, the distance between the load cell and the sling bar may impact the accuracy of the mass measurement. If the load cell is positioned far from the sling bar in an overhead patient lift system, it can have a negative impact on measurement accuracy. The distance between the load cell and the sling bar creates a lever arm effect, which can introduce additional forces and inaccuracies into the weight measurement. When the load is applied to the sling bar, the load cell measures the tension or force at its specific location. However, if the load cell is far from the sling bar, the force applied to the sling bar may not be accurately captured by the load cell due to the lever arm effect. This can result in an overestimation or underestimation of the actual weight being lifted. The longer the distance between the load cell and the sling bar, the greater the lever arm effect and the potential for measurement errors. It is important to minimize this distance and keep the load cell as close to the sling bar as possible to ensure more accurate weight readings.

### SUMMARY OF THE INVENTION

The shortcomings of the prior art are generally mitigated by an in-line lift system which allows the load cell to be position within the lifting mechanism itself while still enabling the rotation of said lifting mechanism under the weight of a patient.

In a preferred embodiment of the present invention, the patient lift system with a scale comprises a sling bar, a load cell, a cradle, an attachment cup, and a scale system. The sling bar is designed to encase the load cell, the cradle, and the scale. The attachment cup holds the lift system in suspension and may rotate to allow the rotation of the lift system.

Integrating load cells or scales within the sling bar of an overhead patient lift system may have several advantages. Furthermore, the measurement of the force applied during patient transfers becomes more precise. The compact design aims at eliminating the need for additional external components, resulting in a streamlined and efficient lifting system. The integration of the load cells generally improves safety as the risk of load cell detachment or disconnection is reduced. The integrated load cell may further simplify setup and operation by eliminating the need for calibration or alignment of external load cells. Additionally, maintenance and durability may be improved by minimizing wear and potential maintenance requirements associated with external load cell attachments. Sling bars with integrated load cells provide caregivers and healthcare professionals aim at providing a convenient and reliable solution for accurate patient weight measurement during lifting procedures.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is an exploded perspective view of an embodiment of a patient lift system comprising an integrated load cell according the principles of the present invention.

FIG. 2 is a top perspective view of the patient lift system of FIG. 1.

FIG. 3 is a top view of the patient lift system of FIG. 1.

FIG. 4 is a left side view of the patient lift system of FIG. 1.

FIG. 5 is a front view of the patient lift system of FIG. 1 showing the sling bar in a horizontal position.

FIG. 6 is a front view of the patient lift system of FIG. 1 showing the sling bar in a right tilt position.

FIG. 7 is a front view of the patient lift system of FIG. 1 showing the sling bar in a left tilt position.

FIG. 8 is a perspective view of a pivoting assembly of a patient lift system according the principles of the present invention.

### DETAILED DESCRIPTION OF THE INVENTION

A novel system and method to lift and weigh a patient will be described hereinafter. Although the invention is described in terms of specific illustrative embodiments, it is to be understood that the embodiments described herein are by way of example only and that the scope of the invention is not intended to be limited thereby.

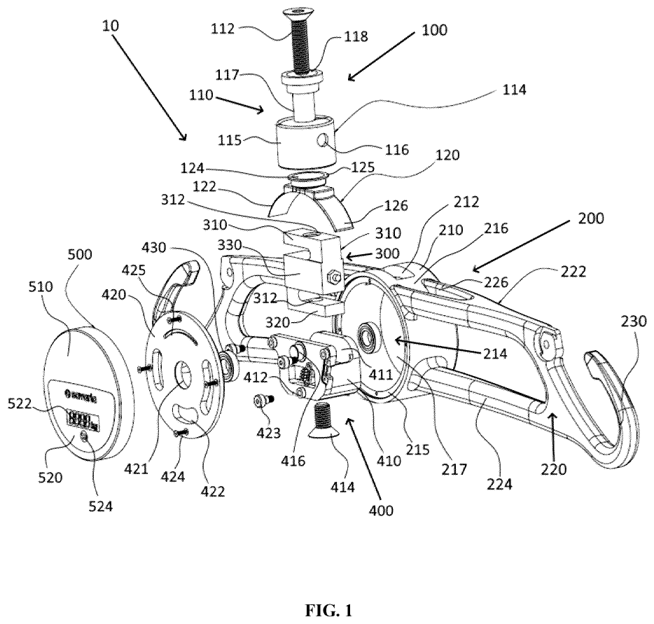

Referring to FIG. 1, an exploded view of an embodiment of a system to lift and weigh a patient 10 is shown. The system 10 comprises an attachment or suspending assembly 100, a sling bar 200, a load cell 300 and a pivoting assembly 400. The attachment system 100 is typically attached to a lifting system (not shown) such as an electric motor. The system 10 may further comprise a cover 500.

The attachment system 100 generally allows suspending the weight of the patient under the lifting system. The attachment system 100 generally dictates the operational axis of the in-line tension. The suspending system 100 generally comprises an anchoring means 110. The anchoring means 110 allows attaching the attachment system 100 to the lifting system. In the illustrated embodiment, the anchor means 110 comprises threaded bolt or fastener 112 attachable to a top portion 312 of the load cell 310. The anchor means 110 may further comprise a rotating attachment element 114 adapted to be attached to a band of the lifting system. The lifting system is attached to the ceiling or to a railing (not shown). The attachment system 100 may further comprise a cover 120 adapted to mate and slide over a top portion of the slot 212. The rotating attachment element 114 allows to pivotably attach the sling bar to the attachment system 100. The rotating attachment element 114 may be embodied as a cylindrical portion 115 having a transversal aperture 116 and a spacer, standoff or sleeve 117 (referred as a sleeve for concision) comprising an aperture 118 allowing passage of the threaded bolt 112 toward the load cell 310. The said rotating attachment element 114 is attachable to the lifting system (not shown), typically through the transversal aperture 116. The sleeve 117 connects the cylindrical portion 115 against the load cell 310 while allowing rotation of the said cylindrical portion 115.

The width of the slot 212 is generally sized to allow passage of the sleeve 117 adapted to receive the fastener 112. In some embodiments, the diameter of the sleeve 117 may be small enough to fit the width of the slot 212.

The slot cover 120 typically comprises a curved body 122 and an aperture or thrust bushing 124. The curved body 122 may slide over a mating a central curved central portion 210 of the sling bar 200. The aperture or thrust bushing 124 generally allows passage of the threaded bolt 112 and of the sleeve 117. The aperture or thrust bushing 124 may further comprise a lip or edge 125 to rotatably receive a lip or edge of the rotating attachment element 114.

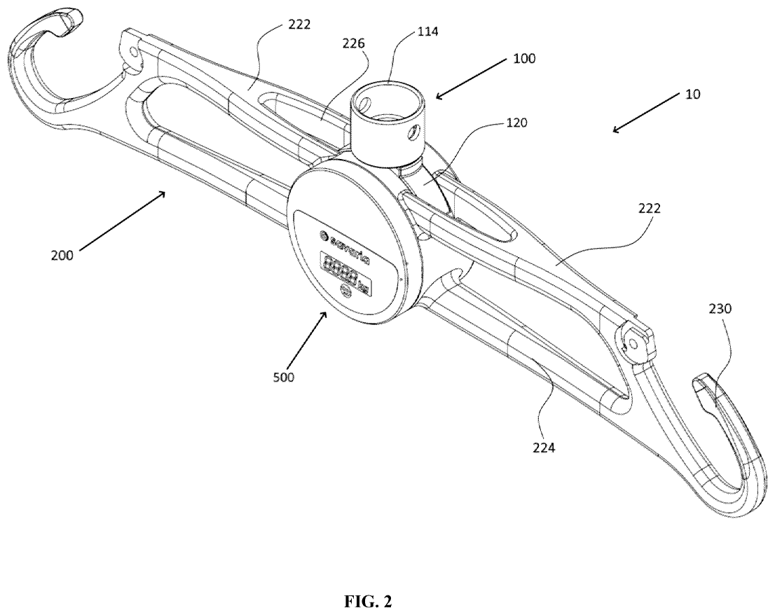

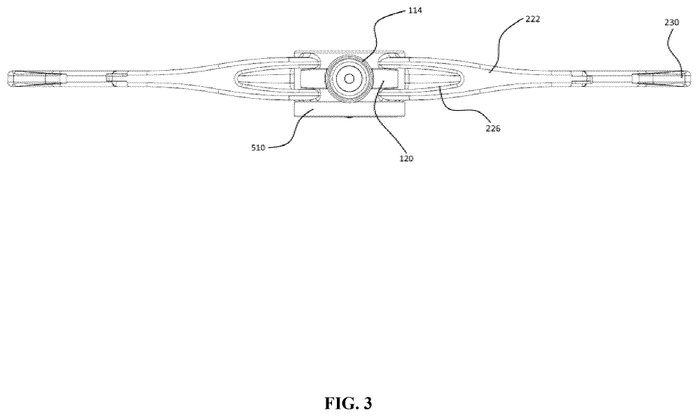

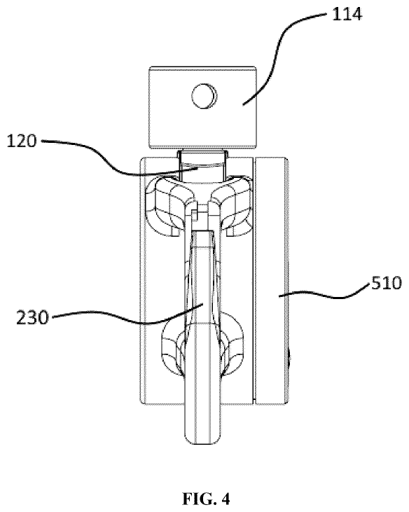

Now referring to FIGS. 1 to 4, the sling bar 200 comprises a central portion 210, a pair of bar arms 220, and a pair of hooks 230. The central portion 210 generally a hole or slot 212 and a cavity or recess 214. The central portion 210 is typically cylindrical in shape. Regardless of the shape of the central portion 210, a top portion 216 of the central portion 210 has a shape matched by the shape of the curved body 122 of the slot cover 120. The passage or slot 212 is located on the top portion 216 of the central portion 210. The passage is generally elongated as to guide the pivoting of the sling bar 200 in relation to the suspending system 100. As such, the slot 212 may be rectangular in shape.

Each of the bar arms 220 may comprise an upper structure 222 and a lower structure 224 connected at one end to the central portion 210 and at another end to a hook 230. The top structure 222 may further comprise an arm hole 226 as to allow the movement of the slot cover 120 over the top portion 216 of the central portion 210. A bottom portion 126 of the slot cover 120 may be respectively larger and longer than the width and length of the slot 212. In some embodiments, the bottom part 126 of the slot cover 120 is reinforced using additional elements to prevent wear over time.

The hooks 230 may be placed at the extremities of each bar arm 220. In embodiments having top 222 and bottom 224 structures, the hook 230 may join the top structure 222 and the bottom structure 224. When the sling bar 200 rotates about the axis of the central portion 210, the slot cover 120 slides over the top portion 216 of the central portion 210. As such, the sling bar 200 may rotate around a central axis without being hindered.

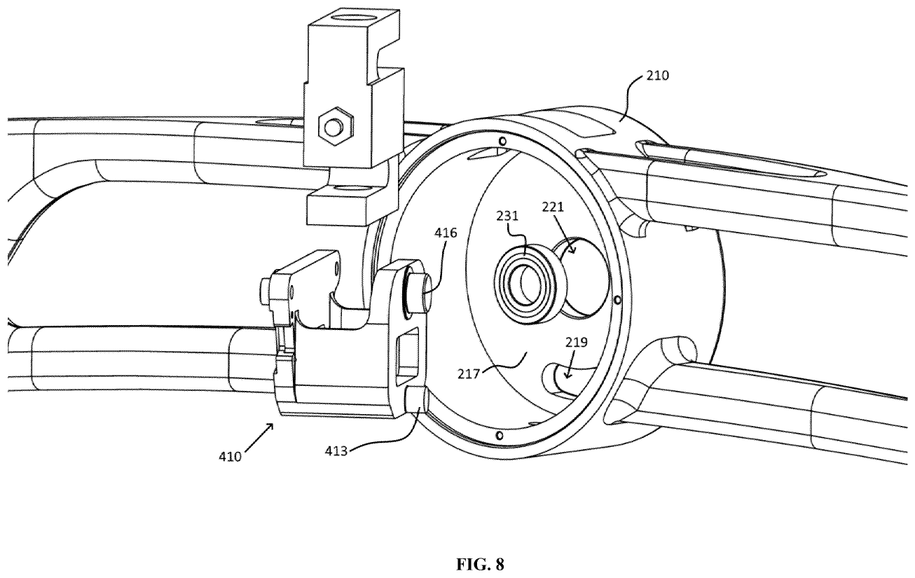

Referring now to FIG. 8, a perspective exploded view of the central portion 210 is illustrated. The central portion 210 may further comprise a back portion or cover 217. The back portion or cover 217 may comprise an aperture 221 or a recess (not shown) adapted forming a central axis of rotation. The aperture 221 may be adapted to receive a bearing 231, such as a press-fitted bearing. The bearing 231 comprises a recess or aperture adapted to receive a protuberance 416 of the cradle 410. As such, the cradle 210 is pivotally mounted to the back cover 217.

Still referring to FIGS. 1 to 4, the load cell 300 comprises an upper portion 310, a lower portion 320, a least one strain gauge 330. The load cell 300 is shaped to be circumscribed within the recess portion 214 of the central portion 210. The load cell 300 may be embodied as a tension load cell such as a S-type load cell. The load cell 300 is attached or received by the pivoting assembly 400 which pivots about the central axis of the sling bar 200. As such, the load cell 300 is positioned about or near the said central axis of the sling bar 200. The load cell 300 shall not move or pivot even if the sling bar 200 is tilted. As such, the load cell 300 may be pivotally attached within the sling bar 200, such as within the central portion 210.

In the illustrated embodiment, the fastener 112 respectively passes through the rotating attachment element 114, the aperture or thrust bushing 124 of the slot cover 120 and the slot 212 of the sling bar 200. The fastener 112 is attached to the upper portion 310 of the load cell 300. In a preferred embodiment, the upper portion 310 comprises a threaded aperture 312 adapted to receive the threaded bolt 112. The lower portion 320 of the load cell 300 may further comprise a threaded aperture 312 adapted to receive a lower threaded bolt 414 to mount the said load cell 300 to the cradle 410. The load cell 300 is held in tension between the suspending system 100 and the pivoting assembly 400. Thus, any load applied on the sling bar 200 is measured by the load cell 300.

The system 10 generally allows that the suspended components are aligned with a vertical axis along the anchoring means 110.

The pivoting assembly 400 comprises a cradle or rocker arm 410 and a covering member 420. The cradle 410 is adapted to receive the load cell 300. The cradle 410 is shaped to be held within the recess 214 of the central portion 210 and the covering member 420. The cradle 410 is pivotally attached to the sling bar 200 and maintains the load cell 300 substantially vertical during any tilting or pivoting of the sling bar 200. The cradle 410 comprises a recess or cavity 411 shaped to receive at least the lower portion 320 of the load cell 300. The cradle 410 further comprises one or more pivot points 416. In the illustrated embodiment, the pivot points 416 are cylindrical protuberances, typically located on each side of the cradle 410. Each of the cylindrical protuberances 416 is adapted to be received by a bearing or bushing 231. The bearing or bushing 231 may be press or slide fitted in an opening 221 of the movement limiting member 420 and in pivoting member of the back cover 217 of the central portion 210. The protuberances received by the two bearings 231 form a pivot axis for the cradle 410. As such, the cradle 410 may pivot or rotate along a substantially horizontal axis passing through the center portion 210. As such, when the sling bar 200 is pivoted, the cradle 410 remains substantially horizontal thus maintaining the load cell 300 vertically aligned regardless of the pivoting angle of the central portion 210 with regard to the cradle 410. Understandably, any other means or mechanism to allow pivoting of the cradle 410 within the central portion 210 being able to sustain a predetermined load may be used within the scope of the present invention.

The cradle 410 further comprises a load cell attachment member 414 to mount the lower portion 320. In the illustrated embodiment, the load cell attachment member 414 is a threaded bolt mating with a threaded aperture of a lower portion 320 of the load cell 300.

Still referring to FIGS. 1 to 4, the cover 420 generally allows the passage of connections and cables from the cradle 410 to the front face 500. The passage shall not interfere the with movement of the sling bar 200. Furthermore, the passage generally aims at limiting application of any undesirable load or force on the load cell 300. In the illustrated embodiment, the front cover 420 is embodied as a plate covering the recess portion 214 of the central portion 210. The front cover 420 may comprise slots or guiding apertures 422. The slots 422 are adapted to slidingly receive fasteners 423 attachable to the cradle 410. The slot 422 is typically curved to follow the rotation of the sling bar 200. In the illustrated embodiment, the cradle 410 comprises threaded apertures 412 for receiving the fasteners 423. The front cover 420 may further comprise fasteners 424 adapted to attach the said front cover 420 to the central portion 210. The front cover 420 may further comprise an aperture or a recess 425. The recess 425 is generally used to receive an angle sensing system. In some embodiments, the angle sensing system may be embodied as a series of fixed magnets (not shown) having different magnetic strengths adapted to measure the rotation angle of the sling bar 200. Understandably, any other means known to a person skilled in the art may be used as a way to measure the current rotation angle of the sling bar 200.

The cradle 410 further comprises threaded apertures 412 adapted to receive the fasteners 423. The fasteners 423 and/or threaded apertures 412 are attachable to the cover 500. The cover 500 may be attached to the cradle 410 for the cover 500 to stay aligned with the position of the cradle 410 with regard to the pivoting sling bar 200. In some embodiments, the cover 500 comprises inner attachment members attachable to the fasteners 423 or to the threaded apertures 412.

Referring to FIG. 8, the cradle 410 may further comprise a rotation limiting member 413, such as a cylindrical protrusion. The rotation limiting member 413 is insertable in a slot or aperture 219 of the back cover 217. The slot 219 is typically curved to guide the rotation and to limit the angle of rotation of the sling bar 200 with regard to the cradle 410. The back cover 217 is typically may of rigid material and may be unitary with the sling bar 200. Understandably, any other mechanism or method to limit the rotation of the sling bar 200 may be used within the scope of the present invention.

The cradle 410 may further comprise a rear pivoting point 416 for allowing rotation of the sling bar 200 with regard to the cradle 410. The rear pivoting point 416 may be embodied as a protrusion, such as a cylindrical protrusion, adapted to be inserted into 231a central portion of a bearing 231. The bearing 231 is typically press fitted in an aperture 221 of the back cover 217. The cradle 410 may further comprise a front pivoting point 416 adapted to be received by a bearing 231. The bearing 231 may be press fitted or mounted in an aperture 221 of the front plate 420. Both pivoting points 416 form a pivoting axis, substantially horizontal, to maintain the cradle 410, and the received load cell 310 substantially leveled within the sling bar 200.

The front cover 420 may further comprise pockets or recesses 425 adapted to receive magnets or other sensors (not shown) for measuring the angle of rotation of the sling 200 in real time.

The central portion 210 may comprise a lip or edge 215. The lip 215 is adapted to receive and mount a portion of the front cover 420. The front cover 420 is mounted to the central portion 210 the cradle 410 and the load cell 300. Understandably, any other known method to attach or mount the front cover 420 to the sling bar 200 or to the central portion 210 may be used within the scope of the present invention. In the illustrated embodiment, the front cover 420 rotates with the sling bar 200.

The cover 500 generally comprises a body portion 510 and a display unit 520. The body portion 510 is generally shaped to cover the central portion 210. The display unit 520 is in data communication with the load cell 300. The load cell 300 is configured to transmit a signal or voltage representing a load applying a tension on the load cell 300. The system 10 may further comprise a controller for calculating the weight based on the measurement received from the load cell 300. The display unit 520 may further comprise a screen 522, buttons 524, such as a reset button, and a battery (not shown). The cover 500 may be attached to the patient lift system 10 using any type of fasteners or may be snapped fit or attached to the cradle 410 using the fasteners 423.

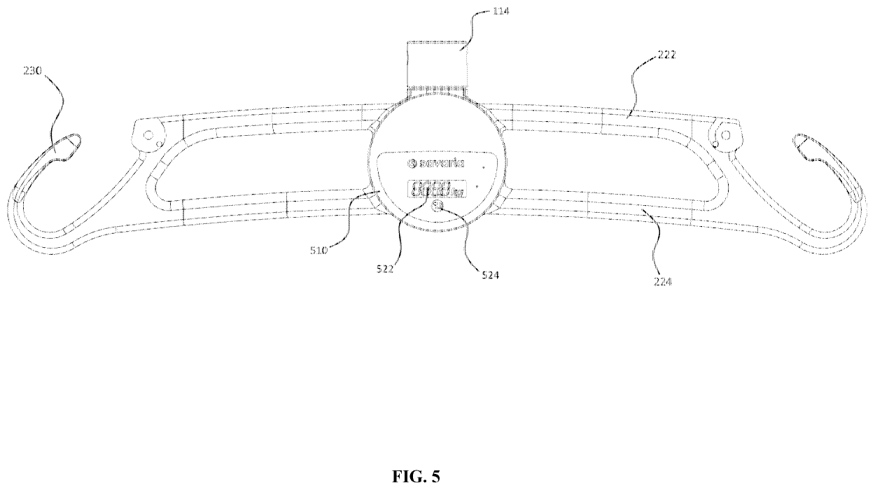

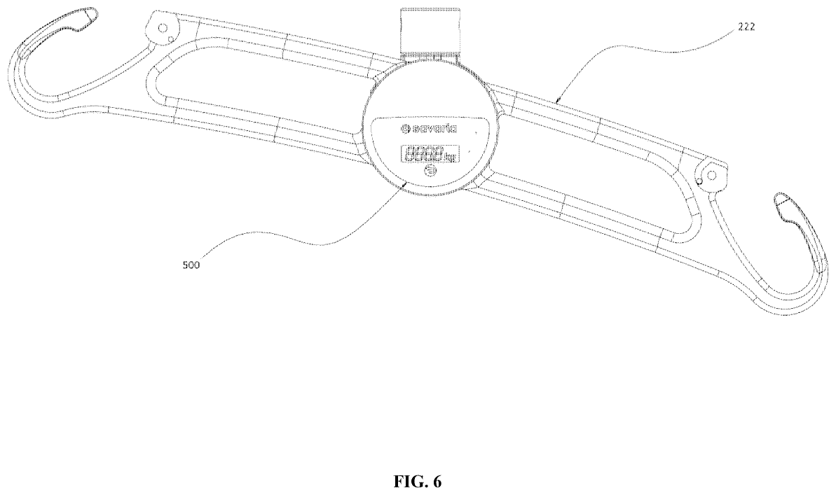

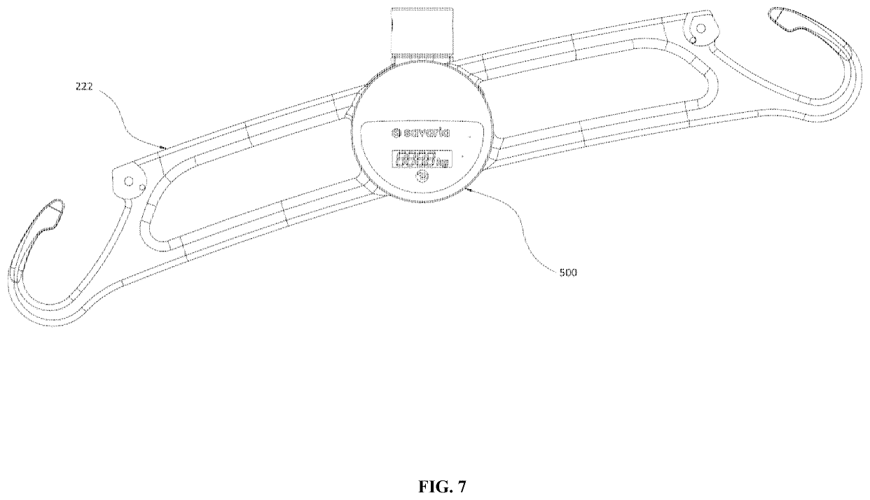

Referring now to FIGS. 5 to 7, the patient lift system 10 is shown in three different positions. In FIG. 5, the patient lift system is in a position of equilibrium when the load attached to both hooks 230 are substantially the same. In FIG. 6, the load attached to the left hook 230 is superior to that of the right hook 230 so that the patient lift system is in a left tilted position. Similarly, in FIG. 7, the patient lift system 10 is in a right tilted position. As can be seen from the FIGS. 5 to 7, the load cell 300 within the cradle 410 remains in a substantial vertical position and the sling bar 200 pivots around the said load cell 300 and/or cradle 410. As such, the load applied on the load cell 300 remains aligned with a vertical axis regardless of the tilting of the sling bar 200. In embodiments having a cover 500, the cover 500 further remain substantially aligned with the cradle 410 as the sling bar 200 is rotated.

A method for measuring weight of a patient while lifting the same is also provided. The method comprises inserting straps under the patient and connecting the said straps to hooks portion of a sling bar. The method further comprises activating a lift motor to enroll a strap pivotally attached to an upper portion of tension load cell being pivotally mounted within a central portion of the sling bar. The method further comprises capturing a load measured by the load cell regardless of the tilting of the sling bar.

The method may further comprise tilting the central portion of the sling bar around a cradle pivotally attached along a vertical axis of a central portion of the sling bar, a lower portion of the load cell being further attached to the cradle. The method may further comprise limiting the pivoting angle of the cradle within the central portion of the sling bar, such as through the use of bolt guided by a recess portion of the back cover.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A patient lift system comprising:
a suspending assembly;
a sling bar pivotally attached to the suspending assembly;
a tension load cell attached to the suspending assembly and pivotally mounted to the sling bar; the tension load cell measuring a vertical load regardless of the pivoted angle of the sling bar.

2. The patient lift system of claim 1 comprising a cradle receiving the tension load cell and being pivotally mounted to the sling bar.

3. The patient lift system of claim 2, the sling bar comprising:
a central portion;
a pair of arms extending from the central portion;
wherein the cradle is pivotally mounted within the central portion.

4. The patient lift system of claim 3, the cradle comprising a cavity shaped to receive at least a lower portion of the tension load cell.

5. The patient lift system of claim 3, the cradle comprising at least one protuberance and the central portion comprising a curved slot receiving the protuberance adapted to limit the pivoting of the sling bar with regard to cradle.

6. The patient lift system of claim 3, the cradle is pivotally mounted to the central portion using bearings.

7. The patient lift system of claim 3, the central portion comprising a slot allows the sling bar to rotate about the suspending assembly.

8. The patient lift system of claim 3, the suspending assembly comprising a slot cover allowing pivoting of the sling bar.

9. The patient lift system of claim 8, the sling bar comprising apertured adapted to receive the slot cover, the slot cover being shaped to adapt to an outer shape of the central portion.

10. The patient lift system of claim 1 further a slot limiting the pivoting of the sling bar with regard to the tension load cell.

11. The patient lift system of claim 1 comprising s a display unit in data communication with the tension load cell to display a load suspended to the system.

12. The patient lift system of claim 11, wherein the display unit being mounted to a front cover being movable with the tension load cell.

13. The patient lift system of claim 1, wherein the load cell is maintained in a substantially vertical position regardless of the pivoting angle of the sling bar.

14. The patient lift system of claim 1, further comprising an angle sensing system configured to measure the rotation angle of the sling bar in real time.

15. A method for measuring the weight of a patient while lifting the patient, the method comprising:
suspending the patient a sling bar suspended to a lift system;
pivoting the sling bar with regard to a horizontal axis;
maintaining a load cell mounted to the pivoted sling bar in substantially vertical position while measuring a load using the load cell regardless of the pivoting angle of the sling bar.

16. The method of claim 15, wherein the step of maintaining the vertical the load cell substantially vertical comprises using a pivoting assembly to keep the load cell vertically aligned.

17. The method of claim 15, further comprising limiting a pivoting angle of a central portion of the sling bar with regard to the load cell.

18. The method of claim 15, further comprising horizontally displaying the measured weight regardless of the pivoting angle of the sling bar.

19. The method of claim 18, further comprising displaying the measured weight on a display unit attached to the sling bar.

20. The method of claim 15, further comprising monitoring the tilting angle of the sling bar to ensure accurate weight measurements.
